(19) United States
(12) Patent Application Publication
(10) Pub. No.: US 2018/0020132 A1
(43) Pub. Date: Jan. 18, 2018

(54) Radiation Detector And Method For Measuring Radiation With A Radiation Detector

(71) Applicant: greateyes GmbH, Berlin (DE)

(72) Inventors: Martin REGEHLY, Berlin (DE); Sebastian RITTER, Berlin (DE); Holger STIEL, Berlin (DE)

(21) Appl. No.: 15/293,668

(22) Filed: Oct. 14, 2016

(30) Foreign Application Priority Data
Jul. 18, 2016 (EP) 16179938.2

(51) Int. Cl. H04N 5/225

(52) U.S. Cl. CPC H04N 5/2252

(57) ABSTRACT

A radiation detector is presented with a detector housing in which a detector chamber is formed; a radiation window, which is integrated into the detector housing in such a way that the radiation to be detected can pass through the radiation window into the detector chamber; a radiation sensor; a mounting device, with which the radiation sensor is mounted on the detector housing; a temperature-regulating device thermally coupled with the radiation sensor in order to temperature-regulate the latter, wherein a dissipation of heat, which arises during the operation of the temperature-regulating device, takes place via the detector housing; and a displacement device, which is disposed on the mounting device and is equipped to displace the radiation sensor in the detector chamber into different measurement positions in which radiation incident at the time can be detected by the radiation sensor.

The present disclosure relates to a radiation detector and a method for measuring radiation with a radiation detector.

### BACKGROUND

A radiation detector for measuring radiation is known from document DE 10 2010 061 079 B4. The radiation sensor used to measure the radiation to be detected is disposed in an evacuated detector housing in the radiation detector, wherein the radiation to be detected passes through a radiation window integrated into the detector housing. During operation, the radiation sensor is cooled with the aid of the temperature-regulating device. Thermal energy thereby arising is dissipated via the detector housing. The radiation sensor can be a cooled CCD camera.

### SUMMARY

It is an object to provide a radiation detector and a method for measuring radiation with a radiation detector, wherein the radiation detector can be adapted individually to different measurement situations in an improved way.

A radiation detector and a method for measuring radiation with a radiation detector are provided in accordance with independent claims 1 and 11. Alternative embodiments are the subject-matter of dependent sub-claims.

According to one aspect, a radiation detector with a detector housing is provided, in which a detector chamber is formed. A radiation window is integrated into the detector housing, which radiation window is permeable for radiation to be detected, in such a way that the radiation to be detected can pass through the radiation window into the detector chamber. A radiation sensor is accommodated in an environment of the detector chamber, in such a way that the radiation passing through the radiation window can be detected by the radiation sensor. A radiation sensor is mounted on the detector housing with the aid of a mounting device. The temperature-regulating device is provided, which is disposed in the detector chamber and is thermally coupled with the radiation sensor in order to temperature-regulate or the temperature-control latter, wherein a dissipation of heat, which arises during the operation of the temperature-regulating device, takes place via the detector housing. The radiation detector comprises a connection device, wherein one or more lines or cables are led out of the detector chamber, in a fluid-tight sealed manner, through the detector housing to the exterior. A displacement device is provided, which is disposed on the mounting device and is equipped to displace the radiation sensor in the detector chamber into different measurement positions in which radiation incident at the time can be detected with the radiation sensor.

According to another aspect, a method for measuring radiation with a radiation detector is provided, wherein a radiation detector is provided in the method, which radiation detector comprises a detector housing with a detector chamber formed therein and a radiation window, which is integrated into the detector housing and is permeable for the radiation to be detected, in such a way that the radiation to be detected can pass through the radiation window into the detector chamber. The radiation detector comprises a radiation sensor, which is accommodated in an environment of the detector chamber, and a mounting device with which the radiation sensor is mounted on the detector housing. In the method, the radiation sensor is temperature-regulated by means of a temperature-regulating device, which is disposed in the detector chamber and is thermally coupled with the radiation sensor. Heat arising during the temperature-regulation or the temperature-control of the radiation sensor is dissipated via the detector housing. For the measurement of the radiation to be detected, the temperature-regulated or temperature-controlled radiation sensor is disposed in a first measurement position inside the detector chamber. The radiation sensor is then displaced into a second measurement position, which is different from the first measurement position, by means of a displacement device disposed on the mounting device. When the temperature-regulated radiation sensor is disposed in the second measurement position inside the detector chamber, radiation to be detected is measured by means of the temperature-regulated radiation sensor.

The environment of the detector chamber receiving the radiation sensor may be an evacuated environment.

The detector housing can be implemented by a plurality of housing parts. For example, one or more lid or top housing parts and one or more bottom housing parts are provided. The radiation sensor may be mounted at the bottom of the detector housing with the aid of the mounting device. The lid or top housing parts can be removed individually or as groups from the bottom housing part or parts, for example for maintenance purposes.

The radiation window which may also be referred to detection window can be disposed in the lid.

The dissipation of the heat arising during operation can take place via the bottom and/or the lid of the detector housing. For this purpose, the respective housing component is coupled thermally with the temperature-regulating device, i.e. in a heat-conducting manner.

The radiation sensor can be a CCD sensor. A high vacuum can be provided in the evacuated environment of the radiation sensor.

The mounting device can be constituted by the displacement device.

The displacement device can comprise a translation device, with which the radiation sensor can be displaced in a translatory manner, for example along at least one translation direction. In an embodiment, the displacement device can be constituted by the translation device. The displacement device can be equipped, with the aid of the translation device, to enable a displacement of the radiation sensor in the x, y or z direction. A displacement along at least two spatial directions at right angles to one another can be provided for. In a simplified embodiment, a translatory displacement capability along only one spatial direction can be provided for. Alternatively or in addition, provision can be made such that the displacement device is equipped to enable a displacement of the radiation sensor around at least one axis of rotation, for example an axis of rotation standing upright on the bottom of the detector housing. The translatory device can for example comprise one or more piezo elements. In an embodiment, the mounting device can be constituted by the translation device.

A checking device can be provided, which is equipped for checking a displacement brought about by means of the displacement device for the radiation detector, for example by means of an optical measurement of the displacement, in order then to compare the result of the optical, an electrical or another measurement, which is suitable for detecting the displacement, with the intended displacement. Provision can thus be made, for example, for comparing the size of the displacement indicated by means of the control signal for the displacement device with the displacement measured after the displacement has taken place, in order in this way to ensure an exact radiation sensor displacement. The checking device can be disposed on the mounting device. The checking device can also be disposed of the housing wall.

The temperature-regulating device can be disposed on the mounting device. The temperature-regulating device or functional parts thereof can be integrated directly into the mounting device. Alternatively, the temperature-regulating device can be disposed detachably on the mounting device, in such a way that the temperature-regulating device can be removed from the mounting device and the mounting of the radiation sensor remains in place in the detector housing. In an embodiment, the mounting device can be constituted by the displacement device and the temperature-regulating device.

For the temperature regulation of the radiation sensor, the temperature-regulating device can be thermally coupled with the radiation sensor via material pieces or elements of the displacement device. The cooling of the radiation sensor can thus be carried out via the material of the displacement device.

For the heat dissipation of heat arising during operation, the temperature-regulating device can be thermally coupled with the detector housing via material pieces or elements of the displacement device. The heat arising during the temperature regulation, in particular cooling, of the radiation sensor can thus be dissipated to the detector housing via the material of the displacement device.

For the heat dissipation of heat arising during operation, the temperature-regulating device can be thermally coupled with the detector housing via a thermal energy conductor, which is constituted so as to permit a displacement of the temperature-regulating device by means of the displacement device. The thermal energy conductor, which can be constituted separate from the temperature-regulating device and/or the displacement device, can be a flexible heat conductor, which automatically adapts its position and shape depending on the displacement position of the temperature-regulating device. The thermal energy conductor can be thermally coupled with one or more housing parts of the detector housing, for example to the bottom and/or a side wall of the detector housing. The thermal energy conductor can be constituted so as to be automatically tracking during the displacement of the temperature-regulating device.

The one or the plurality of lines of the connection device can be constituted so as to permit the displacement of the radiation sensor by means of the displacement device in a manner that does not require readjustment. For example, it may be flexible and/or elastically stretchable electrical connecting lines.

For the cooling energy supply to the radiation sensor, the temperature-regulating device can be thermally coupled with the radiation sensor via a cooling energy conductor, which is constituted so as to permit a displacement of the radiation sensor by means of the displacement device in a manner that does not require readjustment. The cooling energy conductor, which can be constituted separate from the temperature-regulating device and/or the displacement device, can thus undertake a relative movement between the radiation sensor and the temperature-regulating device automatically in a tracking manner.

A sealed fluid connecting piece, e.g. a sealed fluid connecting pipe, can be disposed on the detector housing, via which connecting piece the detector housing can be evacuated and/or filled with a fluid. The fluid connecting piece can be embedded in the detector housing by means of a reversible or a non-reversible seal. The fluid connecting piece can be disposed at the bottom or in the region of a lid component of the detector housing. Helium or nitrogen gas can for example be introduced as a fluid.

The radiation window can be constituted as a closed window, as a result of which the evacuated environment is formed entirely in the detector housing. In this embodiment, the detector housing is constituted as a closed housing. Alternatively, provision can be made such that the radiation window is open and that the detector housing is coupled with an evacuated chamber housing via the open radiation window, wherein the radiation to be detected passes out of the evacuated chamber housing via the open radiation window to the radiation sensor. In such an embodiment, the evacuated environment is extended beyond the detector chamber into the evacuated chamber. At least in the case of the open radiation window, an embodiment can be provided without a sealed fluid connecting piece on the detector housing.

The alternative embodiments explained above in connection with the radiation detector can be accordingly provided in connection with the method for measuring radiation with the radiation detector.

### DESCRIPTION OF EXAMPLES OF EMBODIMENT

Further examples of embodiment are explained below in greater detail by reference to figures of a drawing. In the figures:

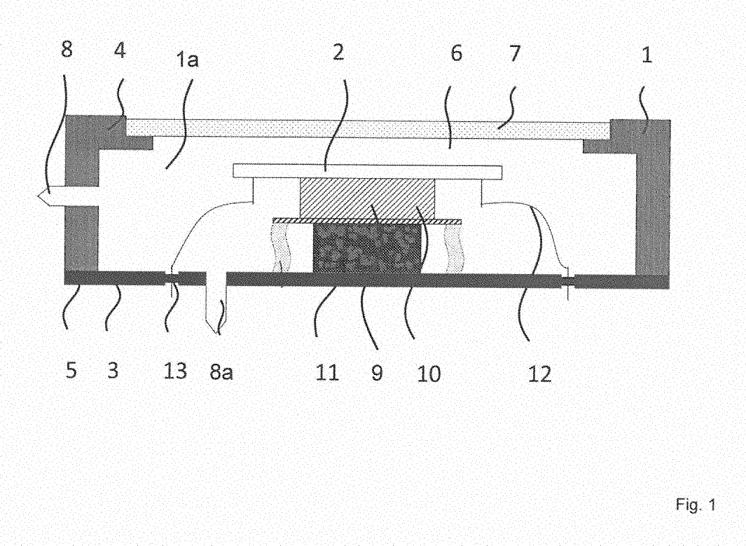

FIG. 1 shows a diagrammatic cross-sectional representation of a radiation detector with a closed radiation window;

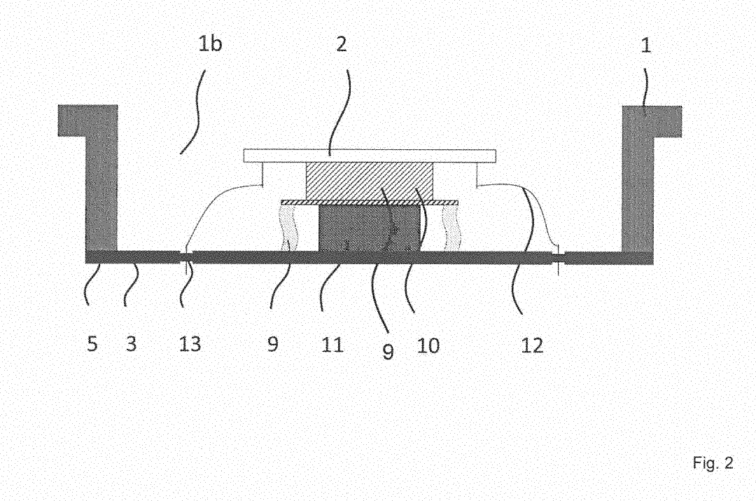

FIG. 2 shows a diagrammatic cross-sectional representation of a radiation detector with an open radiation window;

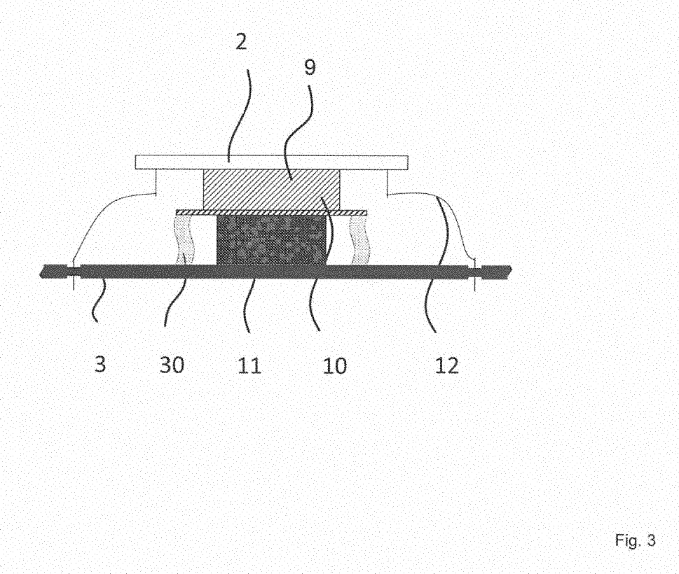

FIG. 3 shows a diagrammatic representation of an arrangement with a radiation sensor, which is mounted on a displacement device and a temperature-regulating device; and

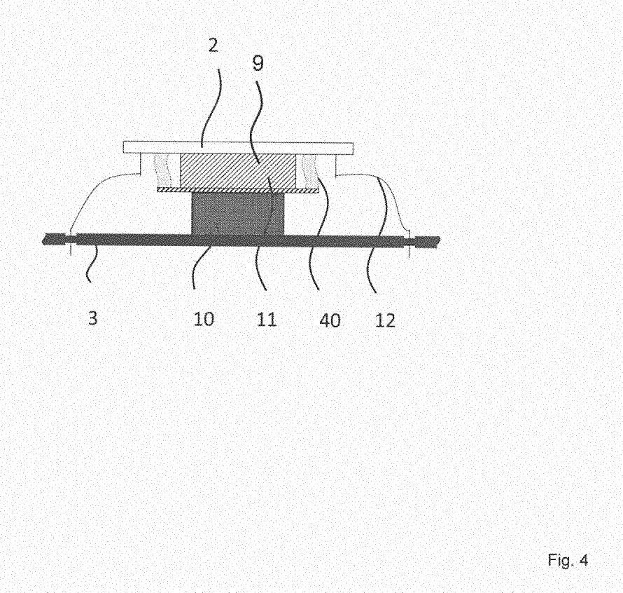

FIG. 4 shows a diagrammatic representation of an arrangement with a radiation sensor, which is mounted on a temperature-regulating device and a displacement device.

FIG. 1 shows a diagrammatic representation of a radiation detector, wherein a radiation sensor 2, for example a CCD sensor, is disposed in an evacuated environment 1a in a detector housing 1. In the embodiment shown, detector housing 1 comprises a bottom part 3 and a top part 4 as housing components. Bottom part 3 and top part 1 are connected via a seal 5.

A radiation window 6 is integrated into detector housing 1, which in the shown embodiment in FIG. 1 is closed with a window part 7. A chamber 1a closed fluid-tight against the surroundings is created in detector housing 1, said chamber being able to be evacuated via a fluid connecting piece 8 in top part 4, for example for the formation of high vacuum. Alternatively or in addition, a fluid can be introduced into closed chamber 1a via fluid connecting piece 8.

In the embodiment shown in FIG. 1, a further fluid connecting piece 8a is provided in bottom part 3, which serves the same purpose as fluid connecting piece 8. It is also possible for only one of fluid connecting pieces 8, 8a to be provided.

Radiation sensor 2 is mounted on bottom part 3 with the aid of a mounting device 9. In the represented embodiment, mounting device 9 is constituted by a temperature-regulating device 10, for example a Peltier element, as well as a displacement device 11, which for example comprises a translation device. With the aid of displacement device 11, radiation sensor 2 can be displaced inside detector housing 1 into different measurement positions, so that radiation passing through radiation window 6 at the time can be detected with the aid of radiation sensor 2.

Connections 12, which serve in particular to supply radiation sensor 2 with electrical energy, are led out of detector housing 1 via fluid-tight housing bushings 13.

Further fluid-tight housing bushings for lines and/or hoses can be provided, for example in bottom part 3, which for example couple with temperature-regulating device 10 in detector housing 1.

FIGS. 3 and 4 show diagrammatic representations, wherein mounting device 9 is constituted by a stacked arrangement of temperature-regulating device 10 and displacement device 11. In the embodiment in FIG. 3, displacement device 11 is disposed on bottom part 3. Temperature-regulating device 10 is mounted on displacement device 11. This arrangement is reversed in the embodiment in FIG. 4.

In the example of embodiment in FIG. 3, thermal heat bridges 30 are provided between temperature-regulating device 10 and bottom part 3. In the embodiment in FIG. 4, thermal cold bridges 40 are disposed between radiation sensor 2 and temperature-regulating device 10 lying below. Thermal heat bridge 30 and thermal cold bridges 40 are constituted separate from temperature-regulating device 10 and displacement device 11.

The features disclosed in the above description, the claims and the drawing can be of importance both individually and in an arbitrary combination for the implementation of the various embodiments.

1. A radiation detector with:
a detector housing in which a detector chamber is formed;
a radiation window, which is integrated into the detector housing and is permeable for radiation to be detected, in such a way that the radiation to be detected can pass through the radiation window into the detector chamber;
a radiation sensor, which is accommodated in an environment of the detector chamber, in such a way that the radiation passing through the radiation window can be detected by the radiation sensor;
a mounting device, with which the radiation sensor is mounted on the detector housing;
a temperature-regulating device, which is disposed in the detector chamber and is thermally coupled with the radiation sensor in order to temperature-regulate the latter, wherein a dissipation of heat, which arises during the operation of the temperature-regulating device, takes place via the detector housing;
a connection device, wherein one or more lines are led out of the detector chamber, in a fluid-tight sealed manner, through the detector housing to the exterior; and
a displacement device, which is disposed on the mounting device and is equipped to displace the radiation sensor in the detector chamber into different measurement positions in which radiation incident at the time can be detected with the radiation sensor.

2. The radiation detector according to claim 1, wherein the displacement device comprises a translation device with which the radiation sensor can be displaced in a translatory manner.

3. The radiation detector according to claim 1, wherein the temperature-regulating device is disposed on the mounting device.

4. The radiation detector according to claim 1, wherein, for the temperature regulation of the radiation sensor, the temperature-regulating device is thermally coupled with the radiation sensor via material pieces of the displacement device.

5. The radiation detector according to claim 1, wherein, for the heat dissipation of heat arising during operation, the temperature-regulating device is thermally coupled with the detector housing via material pieces of the displacement device.

6. The radiation detector according to claim 1, wherein, for the heat dissipation of heat arising during operation, the temperature-regulating device is thermally coupled with the detector housing via a thermal energy conductor, which is constituted so as to permit a displacement of the temperature-regulating device by means of the displacement device.

7. The radiation detector according to claim 1, wherein the one or the plurality of lines of the connection device are constituted so as to permit the displacement of the radiation sensor by means of the displacement device in a manner that does not require readjustment.

8. The radiation detector according to claim 1, wherein, for the cooling energy supply to the radiation sensor, the temperature-regulating device is thermally coupled with the radiation sensor via a cooling energy conductor, which is constituted so as to permit a displacement of the radiation sensor by means of the displacement device in a manner that does not require readjustment.

9. The radiation detector according to claim 1, wherein a sealed fluid connecting piece is disposed on the detector housing, via which connecting piece the detector housing can be evacuated and/or filled with a fluid.

10. The radiation detector according to claim 1, wherein the radiation window is constituted as a closed window, as a result of which the evacuated environment is formed entirely in the detector housing.

11. A method for measuring radiation with a radiation detector, wherein the method comprises
provision of a radiation detector, with
a detector housing in which a detector chamber is formed;
a radiation window, which is integrated into the detector housing and is permeable for radiation to be detected, in such a way that the radiation to be detected can pass through the radiation window into the detector chamber;
a radiation sensor, which is accommodated in an environment of the detector chamber, and
a mounting device, with which the radiation sensor is mounted on the detector housing;
temperature regulation of the radiation sensor by means of a temperature-regulating device, which is disposed in the detector chamber and is thermally coupled with the radiation sensor;
dissipation of heat arising during the temperature regulation of the radiation sensor via the detector housing;
measurement of the radiation to be detected by means of the temperature-regulated radiation sensor when the latter is disposed in a first measurement position inside the detector chamber; and
displacement of the radiation sensor into a second measurement position, which is different from the first measurement position, by means of a displacement device disposed on the mounting device and measurement of the radiation to be detected by means of the temperature-regulated radiation sensor when the latter is disposed in the second measurement position inside the detector chamber.
